(19) United States
(12) Patent Application Publication
(10) Pub. No.: US 2003/0012125 A1
(43) Pub. Date: Jan. 16, 2003

(54) Turntablist grip

(76) Inventor: Mar Santos, Las Vegas, NV (US)

Correspondence Address: Mar Santos, 1816 Eastwood Dr., Las Vegas, NV, 89104, US

(21) Appl. No.: 09/901,173

(22) Filed: Jul. 10, 2001

(51) Int. Cl. G11B 3/70; G11B 5/84; G11B 7/26

(52) U.S. Cl. 369/290

(57) ABSTRACT

A gripping surface approximately 6″ inches in diameter adhered around the label of a 12″ vinyl record for providing a means of increasing the amount of grip a dj and\or turntablist might have on the record when used during play in real time to manipulate sound.

### CROSS-REFERENCE TO RELATED APPLICATIONS

None

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

Dj's also known as “turntablists” use 12″ vinyl recordings to create new sounds by advancing the record forward and backward at different speeds and lengths. At many times the record is advanced at extremely high speeds which causes the fingers to loose grip on the record.

What is desired is an extremely thin gripping surface which may be adhered around the label of a 12″ vinyl recording without being to rough on the fingers.

### BRIEF SUMMARY OF THE INVENTION

Accordingly the present invention provides a gripping surface for a 12″ vinyl recording used during play in real-time which is adhered aroung the label of a 12″ vinyl recording.

### BRIEF DESCRIPTION OF THE SEVERAL VIEWS OF THE DRAWING

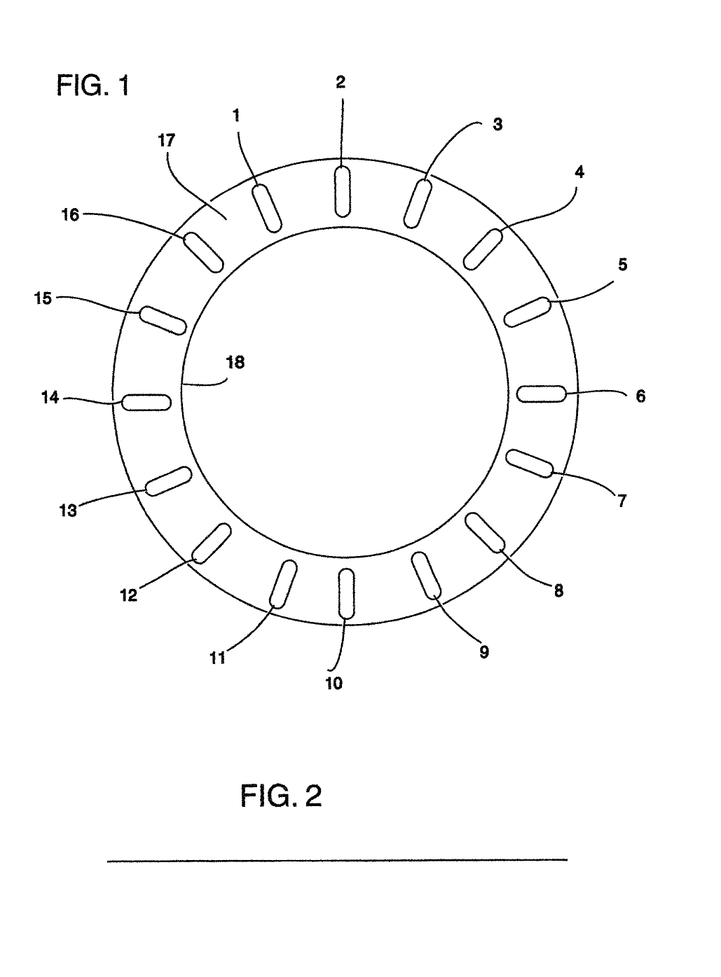

1. FIG. 1 is a top view of the turntablist grip according to the present invention.

2. FIG.2 is a right side view thereof;

3. The rear and left side view is a mirror image of the right side view thereof;

4. No bottom view or description necessary since not visible during use.

### DETAILED DESCRIPTION OF THE INVENTION

Referring now to FIG. 1 respective geometrical holes 1-16 are cut out of an adhering vinyl material 17. The vinyl material 17 has a diameter of 6 inches. The inner circular hole 18 has a diameter of 4 inches leaving space for the label of a 12″ vinyl record to be visible. Any friction producing design may be applied within the diameter of the vinyl material 17 accordingly using today's advanced vinyl cutting machines. It will be adhered around the label of a 12″ vinyl record using the same procedure as one would apply a vinyl graphic sign to a window. The present invention will not disturb playback of a correctly produced vinyl record.

What I claim my invention is:

1. A gripping surface for a 12″ vinyl record providing a means for increasing the amount of grip a dj and\or turntablist might have on the record when used during play in real time.
